(19) United States
(12) Patent Application Publication
(10) Pub. No.: US 2006/0212390 A1
(43) Pub. Date: Sep. 21, 2006

(54) Method and system for direction of funds to non-profits

(75) Inventor: Harry E. Gruber, San Diego, CA (US)

Correspondence Address: Sanjeev K. Dhand;Kintera, Inc., 9605 Scranton Road, Suite 200, San Diego, CA, 92121, US

(73) Assignee: Kintera, Inc.

(21) Appl. No.: 11/081,866

(22) Filed: Mar. 15, 2005

(51) Int. Cl. G06Q 40/00

(52) U.S. Cl. 705/40

(57) ABSTRACT

The disclosed embodiments provide systems and methods for facilitating transfer of funds to a charitable organization or a charitable cause, for example, and facilitate the use of accounts that are established for charitable gift-giving in making contributions to a charitable cause through a website, for example. Such accounts include, but are not limited to, donor advised funds (DAF). A method includes receiving a first signal including instructions, a request or advice indicating a desire to direct one or more payments to a donor-selected charity. At least a portion of the payment is to be transferred from a giving account, the giving account having been established to hold funds for charitable gift-giving.

### BACKGROUND OF THE INVENTION

The present invention relates generally to the field of charitable gift-giving. Specifically, the present invention relates to systems and methods of directing funds to a charity from an account established to hold funds for charitable gift-giving.

Increasingly, charitable organizations are relying upon electronic forms of raising funds. For example, most charitable organizations have websites through which a donor may contribute funds to the charitable organization using credit cards. In certain settings, such as for larger gifts, credit-card payments may be undesirable for various reasons.

It is desirable to provide novel gift-giving systems and methods which facilitate the donation of online gifts, especially large gifts.

### SUMMARY OF THE INVENTION

The disclosed embodiments provide systems and methods for facilitating transfer of funds to one or more charitable organizations or funds restricted to specific charitable purposes or charitable causes within the charitable organizations. Specifically, the disclosed embodiments facilitate the use of giving accounts that are established for charitable gift-giving in making contributions to one or more charitable organizations or restricted or unrestricted funds within the organization through a website, for example. The website may be managed by the receiving charitable organization. Such giving accounts include, but are not limited to, donor advised funds (DAF), family foundations and charitable trusts. Such giving accounts can be used in conjunction with financial accounts, such as checking accounts, debit accounts, credit card accounts or money market accounts.

In one aspect, the invention includes a method of directing funds to a charity. The method includes receiving a first signal from a donor computer. The first signal includes instructions, request or advice indicating a desire to direct one or more payments to a donor-selected charity. At least a portion of the payment is to be transferred from a giving account, the giving account having been established to hold funds for charitable gift-giving.

In one embodiment, the first signal includes a designation of at least one of the following: a cause, a fund, a program, a campaign, a fundraising person and a fundraising team within a charitable organization.

In one embodiment, the method also includes transmitting a second signal to a giving accounts management server, the second signal including a request for transfer of at least a portion of the payment from the giving account. In one embodiment, the payment includes a charitable amount and a value of goods amount. The second signal may include a request for transfer of the charitable amount. In a particular embodiment, when the request for transfer is approved, a transfer of the charitable amount is authorized from the giving account. In one embodiment, the transfer from the giving account is approved before the transfer can be initiated or completed. The second signal may also include a request for transfer of the value of goods amount from a financial account, such as a credit card, debit card, savings or checking account, for example.

In another embodiment, at least one of the first signal and the second signal is transmitted through a communication network. The communication network may be the Internet.

The method may further include transmitting a signal to a funding server associated with a donor-selected charity notifying the donor-selected charity of the payment instructions, request or advice.

In a particular embodiment, the charity server is adapted to allow a donor to select from two or more charities for contribution.

The charity server may be adapted to allow a donor to select from two or more forms of funding the payment, at least one form including a donor advised fund (DAF), a foundation account or a family foundation account.

In another aspect of the invention, a method of directing funds to a charity includes receiving a signal from a charity server by a giving accounts management server. The signal includes a request for transfer of at least a portion of a payment from a giving account managed by the giving accounts management server, the payment being to a donor-selected charity, and the account having been established to hold funds for charitable gift-giving.

In another aspect, a method of directing funds to a charity includes transmitting a signal to a charity server. The signal includes instructions, request or advice indicating a desire to direct at least a portion of a payment from a giving account to a donor-selected charity, the account having been established to hold funds for charitable gift-giving.

Another aspect of the invention includes a system for directing funds to a charity. The system includes a charity server adapted to receive instructions, request or advice from a donor computer indicating a desire to direct a payment to a donor-selected charity. The system also includes an accounts management server adapted to receive a request from the charity server to transfer at least a portion of the payment from an account, the account having been established to hold funds for charitable gift-giving.

### BRIEF DESCRIPTION OF THE DRAWINGS

FIG. 1 is a diagram illustrating a system for directing funds to a charity according to an embodiment of the invention;

FIG. 2A is an exemplary screenshot of a webpage on a charity server according to an embodiment of the invention;

FIG. 2B is an exemplary screenshot of a request-type payment webpage on a charity server according to an embodiment of the invention;

FIG. 3 illustrates an exemplary payment to a charity and its various components;

FIG. 4 is a flow chart illustrating a process according to an embodiment of the invention for directing funds to a charity; and

FIG. 5 is a schematic illustration of a record of a request-type donation.

### DETAILED DESCRIPTION OF THE PREFERRED EMBODIMENTS

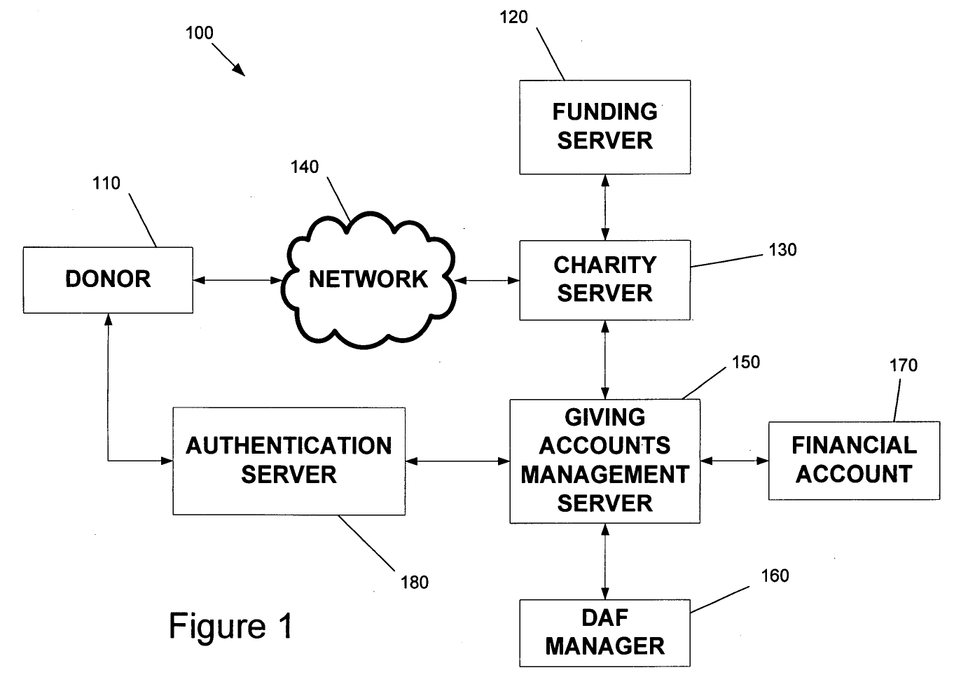

The disclosed embodiments provide systems and methods for facilitating transfer of funds to a charitable organization, an unrestricted fund within the charitable organization or a fund restricted to a specific charitable purpose or charitable cause within the charitable organization. Conventional e-commerce systems have provided for payment for e-commerce transactions using several payment methods, including credit cards and debit cards, for example. As noted above, such methods may be inefficient or inappropriate for use in funding a large donation to a charitable organization, a charity gift from another, an anonymous gift or a gift originally derived from an appreciated asset or from a prior tax reduction motive, for example. Embodiments of the present invention provide novel methods and systems for finding such donations. Specifically, as illustrated in FIG. 1 and described below in greater detail, embodiments of the present invention facilitate the use of giving accounts that are established for charitable gift-giving in making contributions to a charity or a charitable cause through a website, for example. Such accounts allow a donor to set aside funds at one time for later direction to unrestricted or restricted gift to specified charity or charities. In particular, once the funds are allocated to such giving accounts, the donor may request that funds be transferred to a particular charity. The request generally requires approval by an administrator or manager of the account and may require validation from the requestor, or donor. Upon approval, the funds can be transferred.

A donor may access a website, hosted by a charity server, that is operated by a charitable organization, for example. The charity server may include or may communicate with a funding server associated with a particular fund, such as a relief fund for a recent natural disaster. The charity server may also be adapted to communicate with a giving accounts management server for managing one or more accounts for the donor. At least one of the accounts is an account established for holding funds for charitable gift-giving, such as a donor advised fund.

Referring to FIG. 1, a system for directing funds to a charity, charitable organization or a charitable cause is illustrated. The system 100 allows a donor using a donor computer 110 to direct funds to a selected charitable cause through a charity server 130. The donor operating the donor computer 110 may desire to make a contribution to a selected charity. In this regard, the charity server 130 may be associated with one or more organizations, one or more charitable causes or one or more funds within a single organization or a charitable cause, and may be adapted to raise funds for the charities by soliciting and/or accepting contributions from one or more donors.

The donor computer 110 may communicate with the charity server 130 through a variety of means. In a particular embodiment, the donor computer 110 and the charity server 130 communicate through a communication network 140, such as the Internet. The donor computer 110 may be any of a variety of communication devices, including desktop computer, a laptop computer or a handheld device, such as a portable telephone or a personal digital assistant. Thus, the communication between the donor computer 110 and the charity server 130 may be conducted as a standard client-server communication.

In other embodiments, a donor may communicate with the charity server manually by contacting the charity via, for example, telephone, mail or e-mail. The information may then be entered manually by an operator into the charity server.

The charity server 130 may be adapted to solicit and/or accept contributions on behalf of numerous charities, charitable organizations, causes, funds, programs, campaigns, fundraising persons or fundraising teams, each of which is herein referred to generally as a charity. Each such charity may have an associated fund to which donations are directed. Each of the charities may have a server, such as a funding server 120, adapted to communicate with the charity server 130. A funding server 120 may be associated with one or more charities. The communication between the charity server 130 and the funding server 120 may be achieved through a public or private communication network or a secure communication link. In certain embodiments, the communication may be performed manually by entering of data or information by a user. In other embodiments, the functions of the charity server 130 and the funding server 120 may be performed by a single server.

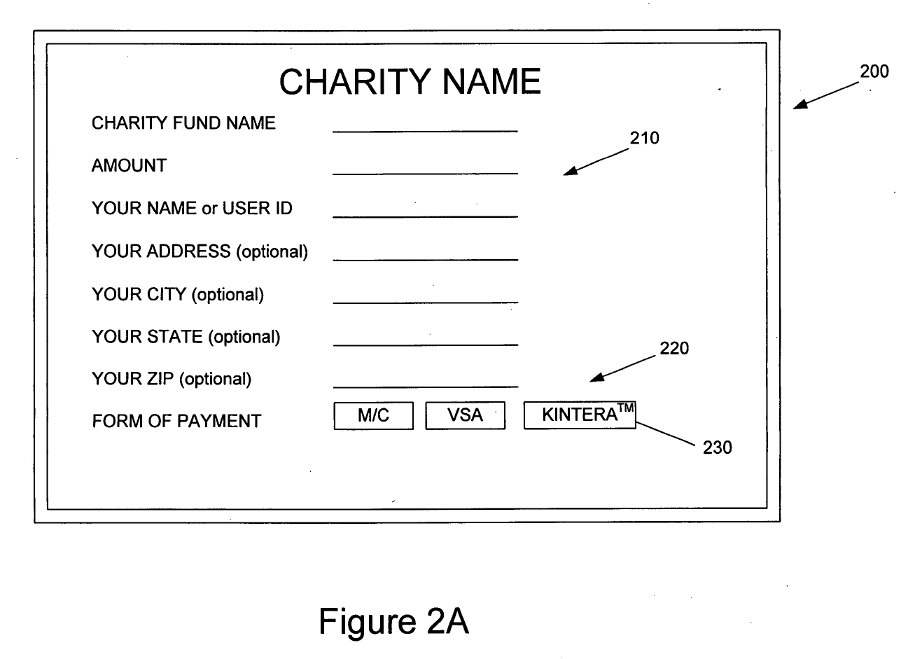

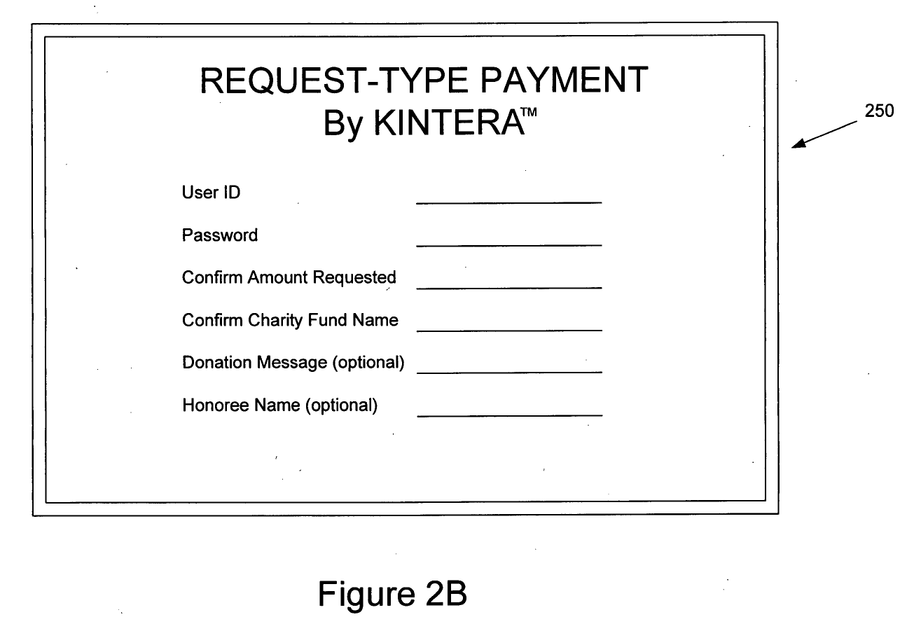

When the donor using the donor computer 110 elects to make a contribution, the donor may be presented with a contribution web page. FIG. 2A illustrates an exemplary contribution web page. The contribution web page 200 may include a form 210 requesting information from the donor relating to the contribution to be made. The form 210 may request information such as the name of the charity fund to which the contribution is to be directed, the amount of the contribution and the donor's personal information. In certain cases, the donor may wish to remain anonymous. In such cases, the donor may use a USER ID registered with the charity server to facilitate tracking of donations by the donor. Additional personal information relating to the donor, such as the donor's address, may be optional.

Although illustrated as blank lines in FIG. 2A, certain items on the form 210 may be selected from a drop-down list. For example, the name of the charity may be selected from a list containing the names of charities, charitable organizations, causes, funds, programs, campaigns, fundraising persons or fundraising teams associated with the charity server 130.

In addition to the information relating to the contribution, the contribution web page 200 may request the donor to specify a form of payment 220. The form of payment selections may include commonly used credit cards or debit cards, for example. In embodiments of the present invention, one form of payment selection may be associated with a payment method, such as a donation account 230, that is associated with an account that is specifically established for charitable gift-giving. In this regard, the donation account 230 may be associated with any account which is established to hold funds for charitable gift-giving, such as a donor advised fund (DAF) or a DAF account. As noted above, such accounts allow the donor to submit a request for transfer of funds, and the request can be approved by an administrator or manager of the account.

In certain embodiments, the donation account 230 may also be linked to other accounts, such as, for example, a credit line, credit or debit account, bank account, charitable remainder trust, pooled income fund account, a gift annuity account or a foundation account, such as a family foundation account. Thus, the donation account 230 may be linked to two or more accounts, at least one of the accounts having been established to hold funds for charitable gift-giving. The donor account 230 or one or more of the accounts linked to the donor account 230 may be associated with one or more pre-approved charities. For example, donations to a specific charitable organization or a charitable fund may have been pre-approved when the giving account 230 is initially set up or at some other time prior to the donor's request.

If the donation account 230 is selected as the form of payment, the donor may be directed to a request-type payment page, as illustrated in FIG. 2B, and be asked to provide information relating to the donor's giving account. As with credit cards, this information may include, for example, an account number, an expiration date and a security code. In this regard, the donor may be asked for a User ID and a password for authentication purposes. The donor may also be asked to confirm the charity fund receiving the payment and the amount of the payment. Additionally, the donor may optionally include a message to accompany the donation and the name of an honoree in whose honor the donation is being made.

Referring again to FIG. 1, when a donor desires to make a contribution to a selected charity using the pre-established account, such as the DAF, the donor computer 110 transmits, by submitting the contribution web page 200 described above with reference to FIGS. 2A and 2B, a signal to the charity server 130 including instructions, a request or advice indicating the desired direction of a charitable payment to the donor-selected charity. The signal is then processed by the charity server 130 to accordingly direct the funds to the selected charity.

In directing the funds, the charity server 130 transmits a signal to a giving accounts management server 150 of an accounts management entity associated with the donor's giving account. The signal from the charity server 130 to the accounts management server 150 includes a request for transfer of the funds to be contributed, along with identification of the donor-selected charity. In certain embodiments, the accounts management entity may also serve as the manager for the DAF account. In such embodiments, the contributed funds may be transferred directly from the accounts management entity to the charity server 130 upon approval of the request.

The charity server 130 may then forward a notification to the funding server 120 notifying the charity of the contribution. The funding server 120 may then track and/or update donation information associated with the donor and/or the donor-selected charity. The charity server 130 may transmit a signal to the funding server 120 prior to the approval or receipt of funds. In this regard, a signal may be transmitted upon receipt of the request from the donor, and the funding server 120 and/or the charity may keep a record of the gift request.

In other embodiments, the giving accounts management entity may be different from a DAF manager. In such embodiments, the giving accounts management server 150 may transmit a signal to a DAF manager server 160 requesting the transfer of funds from the donor's DAF account. Upon receipt of an authorization signal from the DAF manager server 160, the accounts management server 150 may transmit a signal to the charity server 130 indicating approval of the contribution of funds.

Approval of the donation request may require authentication of the donor and validation of the charity, charitable organization or charitable cause. In some cases, the validation of the charity, charitable organization or charitable cause may be pre-approved, as described above. In other cases, such validation may require investigation of the charity, charitable organization or charitable cause, either manually by a user or automatically by the giving accounts management server 150 or the DAF manager server 160. Such investigation may include a determination of registration as a non-profit, for example.

Authentication of the donor may be required to ensure authorized access to the funds. The donor's identity may be authenticated in any of numerous manners. For example, in one embodiment, the donor may include a code, such as a password, with the contribution web page. The code may uniquely identify the donor. In other embodiments, authentication may be performed when the request is received by either the giving accounts management server 150 or the DAF manager server 160. In this regard, authentication may be achieved through a phone call or an e-mail, for example.

In one embodiment, as illustrated in FIG. 1, the giving accounts management server 150 may transmit a message to an authentication server 180, which may transmit an e-mail to the donor 110. The e-mail may include a URL or a link to a web page hosted by the authentication server 180. Upon being accessed by the donor, the web page may identify the donor through a username and password entered by the donor or through a cookie residing on the donor's computer. An acknowledgment of the donor's requested donation to the charity may be provided to the donor. The results of the authentication may then be transferred from the authentication server 180 to the giving accounts management server 150.

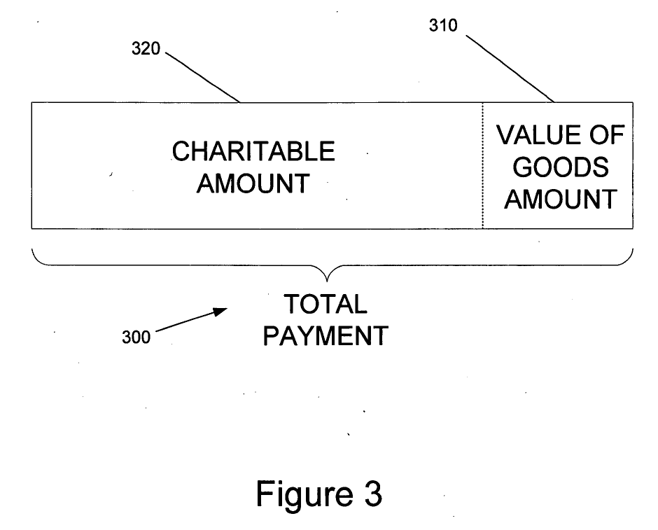

In certain cases, as illustrated in FIG. 3, the charitable payment is a total payment 300 which includes a charitable amount 320 and a value of goods 310. As used herein, “value of goods” may refer to the market value of the goods or services received by the donor. For example, the donor may purchase a table at a charitable dinner for $1,000. The value of the dinner may be $100. Thus, the total payment of $1,000 includes a value of goods of $100 and a charitable amount of $900. In many cases, however, a DAF account may only be used for the charitable amount.

Referring again to FIG. 3, in cases in which the total payment includes a value of goods, the accounts management server 150 may request funds from multiple sources to fund the different components of the payment. For example, the charitable amount may be funded through the DAF, as described above, while the value of goods may be funded through a financial account 170, such as a checking account, a savings account, a credit or debit card account, linked to the donor's authentication or giving account.

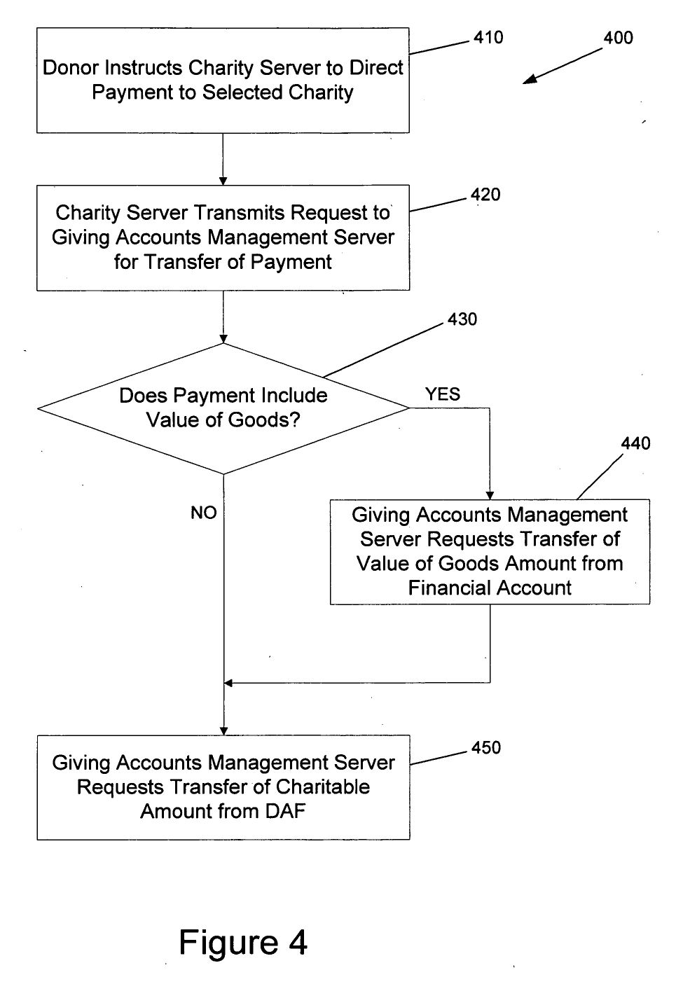

FIG. 4 is a flow chart illustrating an embodiment of a process of directing funds for gift-giving to a charity. The process 400 begins with the donor, through a donor's computer or manually, instructing, requesting or advising the charity server to direct a payment to a selected charity (block 410). The donor may also provide the information identifying the donor's giving account. Upon receiving the instructions, request or advice from the donor, the charity server transmits a request to the giving accounts management server for transfer of the payment (block 420). The request may also include identification of the charity selected by the donor. The giving accounts management server may be associated with the donor's giving account.

At block 430, a determination is made by either the charity server or the giving accounts management server as to whether the payment to the charity includes any non-charitable value of goods. If the charitable payment is determined to not include a value of goods, the process 400 determines that the entire payment to the charity is a charitable amount and proceeds to block 450.

On the other hand, if the payment to the charity is determined to include a value of goods, the giving accounts management server transmits a request for the transfer of the value of goods amount from a financial account, such as a credit or debit card or other account, such as a checking or savings account, linked to the donor's giving account or authentication. The difference between the total payment and the value of goods is determined to be the charitable amount. The process 400 then proceeds to block 450.

At block 450, the accounts management server transmits a request for transfer of the charitable amount from the DAF (or another account established to hold funds for charitable gift-giving).

Although the above-described exemplary embodiments illustrated the use of a DAF, a DAF account or a DAF manager, other accounts having been established to hold funds for charitable gift-giving are contemplated within the scope of the present invention.

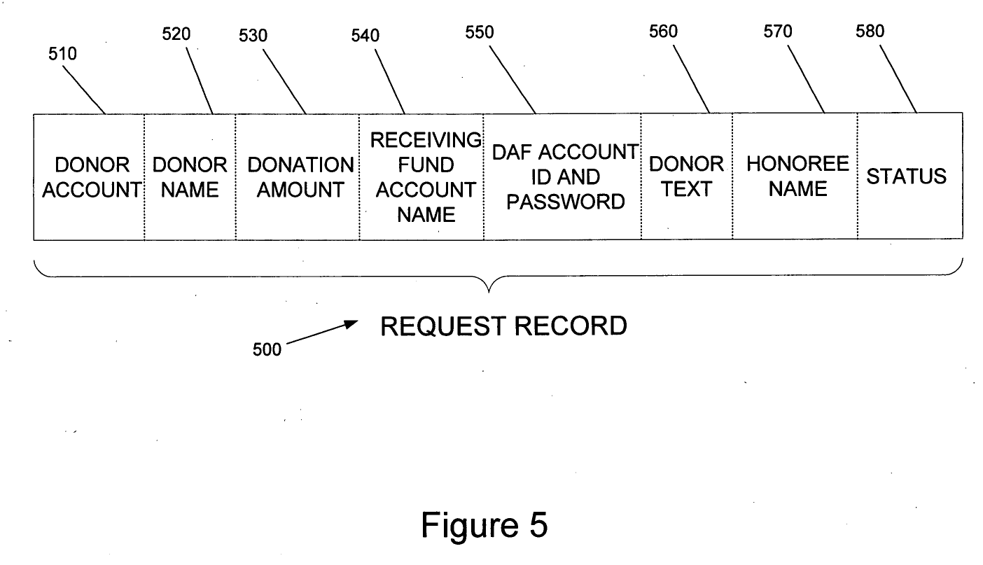

FIG. 5 illustrates an exemplary embodiment of a payment or donation record relating to the request-type payment method described above. The request record 500 may be stored by the charity server, the funding server, the giving accounts management server or any combination thereof. The request record 500 is generally sufficient to identify the donor, any accounts from which funds are to be transferred and the charity, with or without restrictions, to which the funds are to be transferred. Further, the request record 500 may allow the tracking of all donations by the donor to a specific charity and/or to all charities. The request record may also indicate any text which the donor wishes to associate with the donation. For example, the donor may wish to honor an individual with the donation and may wish to include a message in alphanumeric text.

In the illustrated example, the request record 500 includes a donor account field 510 and a donor name field 520 to identify the donor. The donor account field 510 may be associated with the donor for all donations or transactions conducted through the charity server or the charitable organization, for example. In this regard, the donor's account may include all donation regardless of the charity fund receiving a donation or the account from which funds are transferred. The donor name field 520 may be optional to accommodate those donors wishing to remain anonymous.

The exemplary request record 500 also includes a donation amount 530 and a receiving account name 540 to identify the charity to which the funds are to be transferred and an indication of the amount of funds to be transferred.

A DAF account field 550 may be provided to identify the account from which the funds are to be transferred. As with credit card payments, the DAF account field 550 of the request record 500 may include the account number, as well as a password to sufficiently identify the account and to gain access thereto. In a particular embodiment, the DAF account field 550 is encrypted for security purposes.

The request record 500 of FIG. 5 also includes a donor text field 560 to allow storage of the information which the user desires to be associated with the donation. Further, an honoree field 570 may be provided to store the name of any honoree indicated by the donor. The donor text field 560 and the honoree field 570 may be optional. Other fields may be included in the record as necessary. The size of each field in the record may be determined according to the specific needs of the specific application. The record 500 may be maintained by the charity server and/or other entities, such as the giving accounts management server or the fund server. In order to allow such entities to track the progress or status of the donation, a status field 580 may be provided. The status field 580 may indicate whether the direction of funds requested by the donor has been satisfied. In one embodiment, the status field 580 may be populated by an entry selected from a predetermined list. For example, the predetermined list may include entries such as REQUEST RECEIVED, REQUEST TRANSMITTED and REQUEST SATISFIED. Thus, each entity is able to determine the status of the funds.

Thus, the embodiments described above provide systems and methods for allowing charitable gift-giving online in an efficient manner, particularly for large gifts.

The foregoing description of embodiments of the invention have been presented for purposes of illustration and description. It is not intended to be exhaustive or to limit the invention to the precise form disclosed, and modifications and variation are possible in light of the above teachings or may be acquired from practice of the invention. The embodiment was chosen and described in order to explain the principles of the invention and its practical application to enable one skilled in the art to utilize the invention in various embodiments and with various modification as are suited to the particular use contemplated. It is intended that the scope of the invention be defined by the claims appended hereto and their equivalents.

What is claimed is:

1. A method of directing funds to a charity, comprising:
receiving a first signal from a donor computer, the first signal including instructions, a request or advice indicating a desire to direct one or more payments to a donor-selected charity, at least a portion of the payment to be transferred from a giving account, the giving account having been established to hold funds for charitable gift-giving.

2. The method of claim 1, wherein the first signal includes a designation of at least one of the following: a cause, a fund, a program, a campaign, a fundraising person, and a fundraising team within a charitable organization.

3. The method of claim 1, wherein the payment includes a charitable amount and a value of goods.

4. The method of claim 1, further comprising:
transmitting a second signal to a giving accounts management server, the second signal including a request for transfer of at least a portion of the payment from the giving account.

5. The method of claim 4, wherein the payment includes a charitable amount and a value of goods amount.

6. The method of claim 5, wherein the second signal includes a request for transfer of the charitable amount.

7. The method of claim 6, wherein, when the request for transfer is approved, a transfer of the charitable amount is authorized from the giving account.

8. The method of claim 5, wherein the second signal includes a request for transfer of the value of goods amount from a financial account, the financial account being at least one of a checking account, a money market account, a debit account and a credit card account.

9. The method of claim 4, further comprising:
receiving a transfer of funds for the portion of the charitable payment.

10. The method of claim 1, wherein the first signal is transmitted through a communication network.

11. The method of claim 10, wherein the communication network is the Internet.

12. The method of claim 1, further comprising:
transmitting a signal to a funding server associated with a donor-selected charity notifying the donor-selected charity of the payment instructions, request or advice.

13. The method of claim 1, wherein the first signal is received by a charity server and the charity server is adapted to allow a donor to select from two or more charities for contribution.

14. The method of claim 1, wherein the first signal is received by a charity server and the charity server is adapted to allow a donor to select from two or more forms of funding the payment, at least one form being associated with a donor advised fund (DAF), a family foundation or a foundation account.

15. The method of claim 1, further comprising:
receiving a transfer of funds for the portion of the payment.

16. A method of directing finds to a charity, comprising:
receiving a signal from a charity server by a giving accounts management server, the signal including a request for transfer of at least a portion of a payment from a giving account managed by the giving accounts management server, the payment being to a donor-selected charity, the giving account having been established to hold funds for charitable gift-giving.

17. The method of claim 16, wherein the payment includes a charitable amount and a value of goods amount.

18. The method of claim 17, wherein the signal includes a request for transfer of the charitable amount.

19. The method of claim 17, further comprising:
transmitting a second signal to a financial account server, the second signal including a request for transfer of the value of goods amount.

20. The method of claim 19, wherein the financial account server is associated with at least one of a credit line, a credit card, a debit card or a bank account.

21. The method of claim 16, wherein the signal is transmitted through a communication network.

22. The method of claim 16, wherein the giving account is a donor advised fund (DAF), a family foundation or a foundation account.

23. The method of claim 16, further comprising:
causing the transfer of at least the portion of the payment from the giving account to the donor-selected charity.

24. The method of claim 23, wherein the causing the transfer includes validation of the donor-selected charity.

25. The method of claim 24, wherein the validation of the donor-selected charity includes searching a pre-approved list of charities.

26. The method of claim 23, wherein the causing the transfer includes authentication of the donor.

27. The method of claim 26, wherein the authentication of the donor includes receiving a code within the signal from the charity server.

28. The method of claim 26, wherein the authentication of the donor includes contacting the donor by at least one of a telephone call, an e-mail and a letter.

29. The method of claim 26, wherein the authentication of the donor includes receiving an acknowledgment from the donor on a website in response to a request for authentication.

30. A method of directing finds to a charitable cause, comprising:
transmitting a signal to a charity server, the signal including instructions, a request or advice indicating a desire to direct at least a portion of a payment from a giving account to a donor-selected charity, the giving account having been established to hold funds for charitable gift-giving.

31. The method of claim 30, wherein the payment includes a charitable amount and a value of goods amount.

32. The method of claim 31, wherein the instructions, request or advice further indicate a desire to direct the value of goods amount from a financial account to the donor-selected charity.

33. The method of claim 32, wherein the financial account is associated with at least one of a credit line, a credit card, a debit card or a bank account.

34. A system for directing funds to a charity, comprising:
a charity server adapted to receive instructions, a request or advice indicating a desire to direct a payment to a donor-selected charity, at least a portion of the payment to be transferred from a giving account, the giving account having been established to hold funds for charitable gift-giving.

35. The system of claim 34, wherein the charity server is adapted to transmit a request to an accounts management server to transfer the portion of the payment.

36. The system of claim 34, wherein the payment includes a charitable amount and a value of goods amount.

37. The system of claim 34, wherein the charity server is adapted to allow a donor to select from two or more charities for contribution.

38. The system of claim 34, wherein the charity server is adapted to allow a donor to select from two or more forms of funding the payment, at least one form being associated with a donor advised fund (DAF), a family foundation or a foundation account.

39. A system for directing funds to a charity, comprising:
a giving accounts management server adapted to receive a request to transfer at least a portion of a payment from a giving account to a donor-selected charity, the giving account having been established to hold funds for charitable gift-giving.

40. The system of claim 39, wherein the giving accounts management server is further adapted to cause the transfer of at least the portion of the payment from the giving account to a donor-selected charity.

41. The system of claim 39, wherein the giving accounts management server is adapted to transmit a request to a financial account server for a transfer of a value of goods amount to the donor-selected charity.

42. The system of claim 41, wherein the financial account server is associated with at least one of a credit line, a credit card, a debit card or a bank account.

43. A program product of directing funds to a charity, comprising machine-readable program code for causing, when executed, one or more machines to perform the following method steps:
receiving a first signal including instructions, a request or advice indicating a desire to direct one or more payments to a donor-selected charity, at least a portion of the payment to be transferred from a giving account, the giving account having been established to hold funds for charitable gift-giving.

44. A program product of directing funds to a charity, comprising machine-readable program code for causing, when executed, one or more machines to perform the following method steps:
receiving a signal from a charity server by a giving accounts management server, the signal including a request for transfer of at least a portion of a payment from a giving account managed by the giving accounts management server, the payment being to a donor-selected charity, the giving account having been established to hold funds for charitable gift-giving.

45. A program product of directing funds to a charity, comprising machine-readable program code for causing, when executed, one or more machines to perform the following method steps:
transmitting a signal to a charity server, the signal including instructions, a request or advice indicating a desire to direct at least a portion of a payment from a giving account to a donor-selected charity, the giving account having been established to hold funds for charitable gift-giving.

46. A data record, comprising:
at least one field associated with a giving account, the giving account having been established to hold funds for charitable gift-giving; and
at least one field indicating an amount requested to be transferred to a charity, at least a portion of the amount to the transferred from the giving account.

47. The data record of claim 46, further comprising:
a status field indicating the status of a request for transfer of funds from the giving account to a donor-selected charity.
